(19) United States
(12) Patent Application Publication
(10) Pub. No.: US 2012/0287639 A1
(43) Pub. Date: Nov. 15, 2012

(54) Universal mounting bracket with optical functions for use with auxiliary optical devices

(76) Inventor: Leonid Gaber, San Leandro, CA (US)

(21) Appl. No.: 13/068,409

(22) Filed: May 11, 2011

(51) Int. Cl. F21V 14/00; F21V 7/00

(52) U.S. Cl. 362/277; 362/296.01; 362/297

(57) ABSTRACT

The invention provides a mounting bracket for attachment of various auxiliary optical devices such as daylight-vision optical scopes, night-vision monoculars, etc., to a weapon. A distinctive feature of the mounting bracket is that the bracket, itself, incorporates an optical system for projection of an image of the reticle (or other patterns) without use of additional mounts or external reticle or red-dot devices. Most importantly, the bracket allows use of inexpensive optical devices, e.g., a standard monocular, which can be used as a universal optical device, such as an optical sight, a spotting scope, a goggle, a part of a red-dot aiming system, or the like.

### FIELD OF THE INVENTION

This invention relates to an arms sight and, more particularly, to brackets for mounting various auxiliary optical attachments and devices to a basic optical scope. More specifically, the invention relates to a mounting bracket for attaching such devices as day-vision optical scopes and night-vision monoculars to a weapon for use as an optical scope.

### DESCRIPTION OF THE PRIOR ART

A conventional weapon such as a rifle has a mechanical iron sight on the target sight and a rear sight on the viewer sight, and for aiming the weapon must be placed into the position at which the image of the iron sight is aligned with the center of the rear sight. In order to facilitate aiming and to improve accuracy in aligning the front and rear sights, various optical devices that have the image of a reticle or a red dot are used. This is achieved with the use of optical sights.

A great variety of optical sights and scopes differ not only by their functions, such as day-vision optical devices, night-vision optical devices, thermo-vision optical devices, etc., but also by a variety of design and dimensional parameters. An example of an optical sight is the 6X RAPTOR Gen3M646 6X U.S. Military Issue Rifle Scope produced by Night Vision Systems (NVS/DRS). However, such optical sights are very expensive devices. Therefore, attempts were made to replace them with simple and less expensive optical devices such as day-vision and night-vision monoculars.

In addition to high cost, the known optical sights are not sufficiently universal and are intended only for their specific use.

Devices that are used for attaching these optical instruments to a weapon, e.g., a rifle, are known as mounting brackets. Many types of mounting brackets exist, but in many cases weapon manufacturers provide mounting brackets according to their own specifications, and therefore each weapon requires the use of its own mounting brackets.

For example, Tactical Night Vision Company (TNVC) produces a series of weapon mounting brackets intended for attachment of various optical adapters to a weapon, e.g., to a rifle, such as Ideal Scope Mount System ISMS (Cantilever), Universal 1913 Picatinny Scope Mount for Flattop AR-15 Rifles. Mounting Solution Plus (MSP) produces a series of mounts for optical sights such as the PRI Litton PVS-17 Hi-Lo Mount with ARMS Throw Lever. This two-in-one night-vision mount has a unique choice between two different positions: high or low. The user makes the selection to suit his or her needs. The device is constructed of aluminum and steel for strength without extra weight.

If, for example, a rifle is equipped with a red-dot device on the target end of the rifle as a front sight and with a monocular on the viewer side as a rear sight, the optical system requires the use of two mounts for attachment to the rifle, i.e., one mount for the red dot and another mount for the monocular. In this system a red-dot device should be provided with mechanisms for fine adjustment of elevation or windage.

Furthermore, although the use of two mounts is undesirable because they add weight and are more expensive, during the use of a day-vision monocular the quality of the target viewed by the viewer is satisfactory, whereas during the use of a night-vision monocular the quality of the target viewed by the viewer is very poor. This occurs because the field of vision is narrowed and the area around the target is darkened. Furthermore, for better reflection of the red-dot image, the glass of the red-dot device is coated with an antireflective coating, and this impairs the quality of the target view.

### SUMMARY OF THE INVENTION

The present invention provides a mounting bracket for attachment to a weapon, e.g., to a rifle, of various auxiliary optical devices such as daylight-vision optical scopes, night-vision monoculars, etc. A distinctive feature of the mounting bracket of the invention is that the bracket incorporates an optical system for projection of an image of the reticle without use of an additional mount and external reticle or red-dot device. More specifically, the mounting bracket has a bracket body that is provided on its lower side with universal means for securing the bracket to the rifle, e.g., with a dovetail connection. The bracket body has a proximal part and a distal part, which is closer to the target. The proximal part is provided with guides and a clamp for installing and securing an optical accessory on the upper side of the bracket. As mentioned above, such an accessory may comprise a night-vision monocular, e.g., a M914A (AN/PVS-14), which is a multiuse monocular produced by L3 EOS.

The distal part of the bracket body supports an optical mechanism that incorporates a microoptical system consisting of a light-emitting diode (LED), a mirror with an opening having the shape of a reticle, a lens for forming an image of a reticle in infinity, and a light-reflecting prism installed in a hollow projection that is arranged perpendicular to the upper surface of the bracket and is installed in a position such that, when necessary, the body of the projection can be used as a mechanical iron sight. The prisms comprise a first prism component that has a light-reflecting surface inclined at a predetermined angle to the direction of the beam emitted from the LED so that the lightbeam incident to the light-reflecting surface of the first prism component reflects to the second prism component. The second prism component also has a reflecting surface that is inclined at an angle that directs the lightbeam directly into the optical lens of the attached optical accessory, e.g., night-vision monocular, and then through the eyepiece of the optical attachment to the eye of the viewer.

The viewer may perceive the lightbeam as a dot or as another shape in infinity.

As mentioned above, the microoptical system is installed on the optical mechanism, the position of which relative to the optical axis of the optical attachment can be microscopically adjusted with the use of a fine windage or elevation adjustment mechanism. In other words, the elevation and windage positions of the reticle seen by the viewer can be adjusted.

The power of the light emitted by the LED should be in a safe wavelength region that is not harmful to the eye.

### BRIEF DESCRIPTION OF THE DRAWINGS

FIG. 1 is a side view of an optical scope installed on the mounting bracket of the invention.

FIG. 2 is a three-dimensional view of the mounting bracket of the invention with a cutaway portion showing the structure of the optical components of the bracket.

FIG. 3 is another three-dimensional view of the mounting bracket with a cutaway portion showing the structure of the battery compartment.

### DETAILED DESCRIPTION OF THE INVENTION

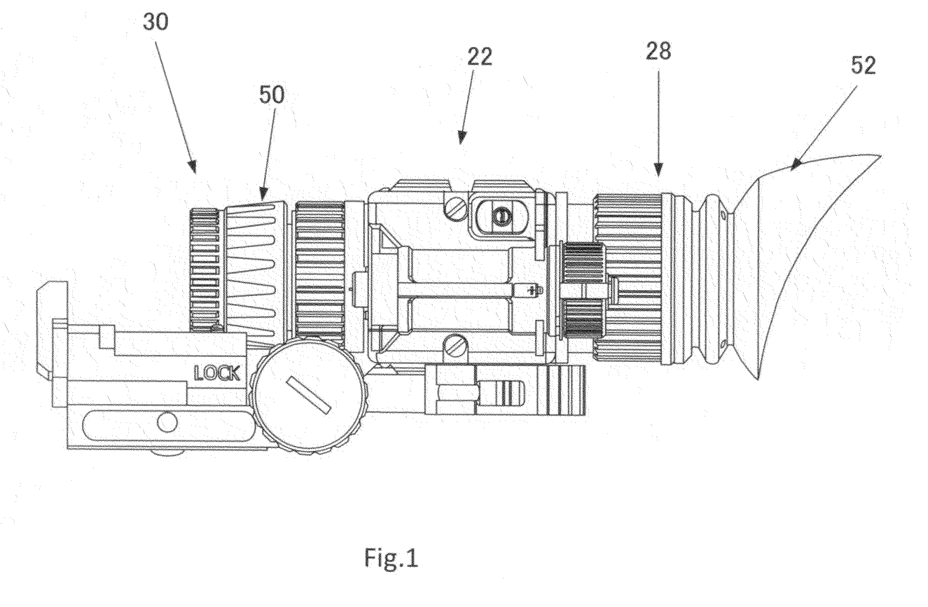

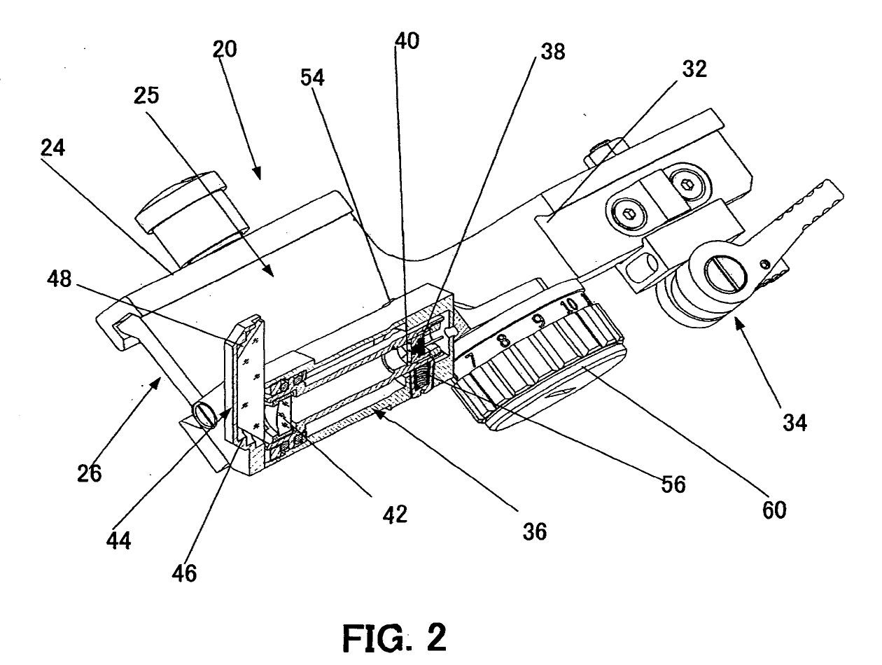

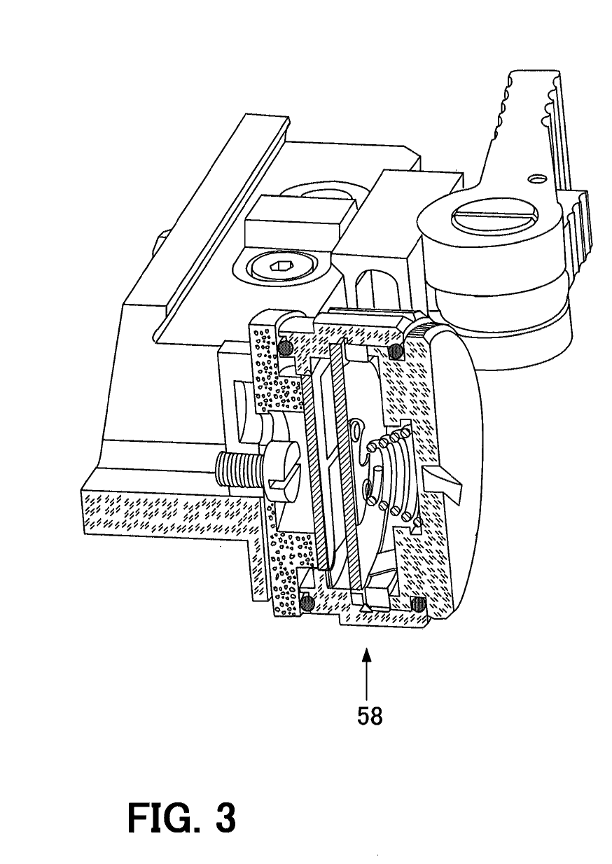

The mounting bracket of the invention is shown in the attached drawings, where FIG. 1 is a side view of an optical scope installed on the mounting bracket of the invention. FIG. 2 is a three-dimensional view of the mounting bracket of the invention with a cutaway portion showing the structure of the optical components of the bracket. FIG. 3 is another three-dimensional view of the mounting bracket with a cutaway portion showing the structure of the battery compartment.

The present invention provides a mounting bracket 20 for attachment to a weapon, e.g., a rifle (not shown in the drawings), of various auxiliary optical devices such as daylight-vision optical scopes, night-vision monoculars, etc. In FIG. 1, such an optical device is shown as a night-vision monocular 22.

A distinctive feature of the mounting bracket 20 of the invention is that the bracket 20 incorporates an optical system for projection of an image of the reticle without use of an additional mount and an external reticle or red-dot device.

More specifically, the mounting bracket has a bracket body 24 with a mounting surface 25 that is provided on its lower side with universal securing means for securing the bracket body 24, e.g., with a dovetail connection 26 (FIG. 2), to an object, such as a rifle (not shown). The bracket body 24 has a proximal part 28 and a distal part 30 (FIG. 1), which is closer to the target. The proximal part is provided with second securing means such as guides 32 and a clamp 34 for installing and securing an optical accessory 22 on the upper side of the bracket. As mentioned above, such an accessory 22 may comprise a night-vision monocular, e.g., a Generation 3 AN/PVS-14, which is a hand-held, helmet-mountable, weapon-mountable monocular produced by ITT.

The distal part of the bracket body supports an optical mechanism 36 that incorporates a microoptical system consisting of a source of light, e.g., a light-emitting diode (LED) 38, a masking means 40 with an opening having the shape of the aiming mark, e.g., a reticle, a lens 42 for forming an image of the reticle in infinity, and a light-reflecting prism 44 installed in a hollow projection that is arranged perpendicular to the mounting surface 25 of the bracket body 24 and is installed in a position such that, when necessary, the body of the projection can be used as a mechanical iron sight. The prism comprises a first prism component 46 that has a light-reflecting surface inclined at a predetermined angle to the direction of the beam emitted from the LED so that the lightbeam incident to the light-reflecting surface of the first prism 46 component reflects to the second prism component 48. The second prism component 48 also has a reflecting surface that is inclined at an angle that directs the lightbeam directly into the optical lens 50 (FIG. 1) of the attached optical accessory 22, e.g., night-vision monocular, and then through the eyepiece 52 of the optical attachment to the eye of the viewer (not shown).

The viewer may perceive the image of the lightbeam as a dot or as other shapes seen in infinity. In FIG. 2, reference numeral 60 designates the mechanism for adjusting brightness of the reticle. As mentioned above, the microoptical system is installed on the optical mechanism 36, the position of which relative to the optical axis of the optical attachment can be microscopically adjusted with the use of a fine windage or elevation adjustment mechanisms 54 and 56, respectively. In other words, the elevation and windage positions of the reticle or dot seen by the viewer can be adjusted.

The power of the light emitted by the LED should be in a safe wavelength that is not harmful to the eye. Shown in FIG. 3 is an arrangement of the battery compartment 58.

Thus, it can be seen that the mounting bracket of the invention is a simple and versatile device. Most importantly, the bracket allows use of an inexpensive optical device, e.g., a standard monocular, which can be used as a universal optical device, such as an optical sight, a spotting scope, a goggle, a part of a red-dot aiming system, or the like.

Although the invention is shown and described with reference to specific embodiments, it is understood that these embodiments should not be construed as limiting the areas of application of the invention and that any changes and modifications are possible provided that these changes and modifications do not depart from the scope of the attached patent claims. The clamp, battery compartment, and windage and elevation adjustment mechanisms may have different designs.

1. A universal mounting bracket for auxiliary optical devices comprising:
a bracket body having a proximal part, a distal part, and a mounting surface with a first securing means for securing the bracket body to an object, and a second securing means for attachment of an auxiliary optical device to the bracket body; and
an optical mechanism that is installed in the bracket body and comprises a source of light, masking means with an opening in the form of an aiming mark for passing light from a light source, a lens for forming an image of the aiming mark in infinity, and a light-reflecting prism for receiving the light that passes through the masking means and for projecting an image of the aiming mark in infinity into the auxiliary optical device when the latter is installed and secured on the bracket body.

2. The universal mounting bracket according to claim 1, wherein the bracket body has an elongated projection that is perpendicular to the mounting surface and contains said light reflecting prism.

3. The universal mounting bracket according to claim 2, wherein the elongated projection comprises a mechanical iron sight.

4. The universal mounting bracket according to claim 1, wherein the source of light is a light-emitting diode.

5. The universal mounting bracket according to claim 3, wherein the source of light is a light-emitting diode.

6. The universal mounting bracket according to claim 3, wherein the masking means is a mirror.

7. The universal mounting bracket according to claim 1, wherein the aiming mark is selected from the group consisting of a reticle and a red dot.

8. The universal mounting bracket according to claim 3, wherein the aiming mark is selected from the group consisting of a reticle and a red dot.

9. The universal mounting bracket according to claim 6, wherein the aiming mark is selected from the group consisting of a reticle and a red dot.

10. The universal mounting bracket according to claim 1, wherein the optical mechanism is further provided with elevation and windage adjustments for moving the optical mechanism relative to the bracket body.

11. The universal mounting bracket according to claim 3, wherein the optical mechanism is further provided with elevation and windage adjustments for moving the optical mechanism relative to the bracket body.

12. The universal mounting bracket according to claim 8, wherein the optical mechanism is further provided with elevation and windage adjustments for moving the optical mechanism relative to the bracket body.

13. The universal mounting bracket according to claim 1, wherein the light-reflecting prism comprises a first prism component that has a first light-reflecting surface inclined at a predetermined angle to the direction of the light emitted from the source of light and a second prism that has a second reflecting surface that is inclined at an angle to the light reflected from the first reflecting surface and directs said image of the aiming mark in infinity into the auxiliary optical device when the latter is installed and fixed on the bracket body.

14. The universal mounting bracket according to claim 3, wherein the light-reflecting prism comprises a first prism component that has a first light-reflecting surface inclined at a predetermined angle to the direction of the light emitted from the source of light and a second prism that has a second reflecting surface that is inclined at an angle to the light reflected from the first reflecting surface and directs said image of the aiming mark in infinity into the auxiliary optical device when the latter is installed and fixed on the bracket body.

15. The universal mounting bracket according to claim 8, wherein the light-reflecting prism comprises a first prism component that has a first light-reflecting surface inclined at a predetermined angle to the direction of the light emitted from the source of light and a second prism that has a second reflecting surface that is inclined at an angle to the light reflected from the first reflecting surface and directs said image of the aiming mark in infinity into the auxiliary optical device when the latter is installed and fixed on the bracket body.

16. The universal mounting bracket according to claim 10, wherein the light-reflecting prism comprises a first prism component that has a first light-reflecting surface inclined at a predetermined angle to the direction of the light emitted from the source of light and a second prism that has a second reflecting surface that is inclined at an angle to the light reflected from the first reflecting surface and directs said image of the aiming mark in infinity into the auxiliary optical device when the latter is installed and fixed on the bracket body.

17. The universal mounting bracket according to claim 14, wherein the aiming mark is selected from the group consisting of a reticle and a red dot.

18. The universal mounting bracket according to claim 1, wherein the auxiliary optical device is selected from a day-vision optical scope, a night-vision monocular, and a day-vision monocular.

19. The universal mounting bracket according to claim 18, wherein the auxiliary optical device is a standard monocular.

20. The universal mounting bracket according to claim 19, wherein the second securing means are means for securing a standard monocular.
